(19) United States
(12) Patent Application Publication
(10) Pub. No.: US 2023/0402957 A1
(43) Pub. Date: Dec. 14, 2023

(54) DEVICES AND METHODS FOR MOUNTING SOLAR PANELS

(71) Applicant: Solar Intermodal Corporation, Roseland, NJ (US)

(72) Inventor: Robert Anderson, Wanaque, NJ (US)

(21) Appl. No.: 18/033,970

(22) PCT Filed: Nov. 1, 2021
(86) PCT No.: PCT/US21/57618

§ 371 Date: Apr. 26, 2023

Related U.S. Application Data
(60) Provisional application No. 63/107,771, filed on Oct. 30, 2020.

(51) Int. Cl. H02S 10/40; H02S 20/30; B61D 45/00

(52) U.S. Cl. CPC H02S 10/40; H02S 20/30; B61D 45/007

(57) ABSTRACT

Railcars are provided, the railcars comprising: a bed; and at least one frame containing at least one solar panel that is moveably attached to the bed such that, in an opened position, cargo can be loaded onto the bed, and such that, in a closed position, the at least one frame at least partially covers the cargo. In some of these railcars, a first frame of the at least one frame has a first top portion that is parallel to the bed and two first side portions that are on opposite long sides of the bed, that are parallel to each other, and that support the first top portion.

### CROSS-REFERENCE TO RELATED APPLICATION

This application claims the benefit of U.S. Provisional Patent Application No. 63/107,771, filed Oct. 30, 2020, which is hereby incorporated by reference herein in its entirety.

### BACKGROUND

Vehicles, such as trains, trucks, and boats, that are used to move cargo containers use energy, in many instances from diesel engines. In order to save money and protect the environment, it is desirable to use solar power to at least partially power such vehicles. However, current techniques for using solar power on vehicles are not suitable for vehicles having shipping containers. Accordingly, new mechanisms for implementing solar panels on vehicles are desirable.

### SUMMARY

In accordance with some embodiment, devices and methods for mounting solar panels are provided. In some embodiments, railcars are provided, the railcars comprising: a bed; and at least one frame containing at least one solar panel that is moveably attached to the bed such that, in an opened position, cargo can be loaded onto the bed, and such that, in a closed position, the at least one frame at least partially covers the cargo. In some of these railcars, a first frame of the at least one frame has a first top portion that is parallel to the bed and two first side portions that are on opposite long sides of the bed, that are parallel to each other, and that support the first top portion. In some of these railcars, a second frame of the at least one frame has a second top portion that is parallel to the bed and two second side portions that are on opposite long sides of the bed, that are parallel to each other, and that support the second top portion. In some of these railcars, a third frame of the at least one frame has a third top portion that is parallel to the bed and two third side portions that are on opposite long sides of the bed, that are parallel to each other, and that support the third top portion, wherein, when in the opened position, the third top portion is at least partially above the first top portion. In some of these railcars, a fourth frame of the at least one frame has a fourth top portion that is parallel to the bed and two fourth side portions that are on opposite long sides of the bed, that are parallel to each other, and that support the fourth top portion, wherein, when in the opened position, the fourth top portion is at least partially above the second top portion. In some of these railcars, the at least one frame has wheels on which the at least one frame rides in a channel formed in the bed. In some of these railcars, the at least one frame is attached to the bed by a hinge that allows the frame to pivot outward from the center of the bed from the closed to the opened position. In some of these railcars, the at least on frame includes a top portion that covers the cargo when in the closed position and that is configured to slide parallel to a top surface of the bed. In some of these railcars, the at least on frame includes a top portion that covers the cargo when in the closed position and that is configured to rotate about an axis parallel to a long side of the bed. In some of these railcars, the railcar further comprises an actuator that causes the at least one frame to move. In some of these railcars, the cargo is a cargo container. In some of these railcars, the cargo is two stacked cargo containers. In some of these railcars, the railcars further comprise an inductive coupling for transferring power from the railcar. In some of these railcars, the railcar is a center-beam railcar.

### BRIEF DESCRIPTION OF THE DRAWINGS

FIG. 1 is an exploded view of example frames for attaching solar panels to cargo containers in accordance with some embodiments.

FIG. 2 is an illustration of example frames attaching solar panels to cargo containers in accordance with some embodiments.

FIGS. 3A and 3B are illustrations of an example base frame in accordance with some embodiments.

FIGS. 4A and 4B are illustrations of an example mezzanine frame in accordance with some embodiments.

FIGS. 5A and 5B are illustrations of an example cap frame in accordance with some embodiments.

FIGS. 6A-6L are illustrations of example frames that can open and close in accordance with some embodiments.

FIGS. 7A-7F are illustrations of example frames that can open and close telescopically in accordance with some embodiments.

FIGS. 8A-8F are illustrations of an example of railcar having inductive couplings at each end of the railcar in accordance with some embodiments.

FIGS. 9A-9F are illustrations of example frames for attaching solar panels to a single cargo container in accordance with some embodiments.

FIGS. 10A-10E are illustrations of example frames for attaching solar panels to a center-beam railcar in accordance with some embodiments.

FIGS. 11A-11C are illustrations of an example car carrier railcar with solar panels attached thereto in accordance with some embodiments.

FIGS. 11D-11E are illustrations of an example car carrier railcar without solar panels attached thereto in accordance with some embodiments.

FIGS. 12A-12C are illustrations of an example tanker railcar with solar panels attached thereto in accordance with some embodiments.

FIGS. 12D-12E are illustrations of an example tanker railcar without solar panels attached thereto in accordance with some embodiments.

FIGS. 13A-13B are illustrations of an example hopper railcar with solar panels attached thereto in accordance with some embodiments.

FIGS. 13C-13D are illustrations of an example hopper railcar without solar panels attached thereto in accordance with some embodiments.

FIG. 14 is a schematic for example circuitry in accordance with some embodiments.

FIG. 15 is a block diagram of an example computer in accordance with some embodiments.

### DETAILED DESCRIPTION

In accordance with some embodiments, devices and methods for mounting solar panels on cargo containers and/or vehicles are provided.

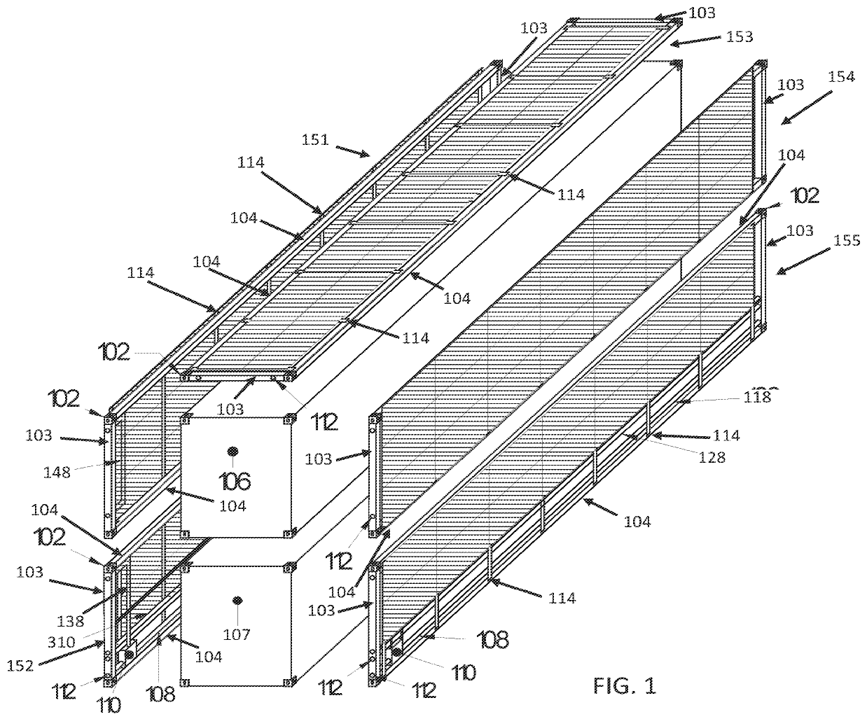

FIG. 1 shows examples of mechanisms for attaching solar panels to cargo containers in accordance with some embodiments. As illustrated, the mechanism can include five (or any other suitable number) solar panel mounting bracket frames 151, 152, 153, 154, and 155. In some embodiments, each frame can be sized in accordance with the sizes of the sides and top of an intermodal cargo container, such as standard intermodal cargo containers 106 and 107. As shown, each frame can be rectangular in some embodiments; however any suitable shape can be used in some embodiments. For example, in some embodiments, a frame can be triangular, square, round, trapezoidal, hexagonal, and/or any other suitable shape. Each frame can be constructed from any suitable material having any suitable shape in some embodiments. For example, in some embodiments, a frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown, in some embodiments, each frame can include standard intermodal cubed corners 102 which can be used to attach the frame to an intermodal cargo container. During operation, each frame can be moved about with standard intermodal cargo container grappling equipment connected to the cubed corners in some embodiments. As shown, each cubed corner 102 of a frame can be constructed from any suitable material having any suitable shape in some embodiments. For example, in some embodiments, each cubed corner 102 of a frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIG. 1, in some embodiments, cubed corners 102 can be connected to side members 103 and length members 104 to form the outside of each frame. As shown, in some embodiments, the side members can be sized in accordance with the height or width of a standard intermodal cargo container. As also shown, in some embodiments, the length members can be sized in accordance with the length of a standard intermodal cargo container. Each side member and each length member can be constructed from any suitable material having any suitable shape in some embodiments. For example, in some embodiments, each side member and each length member can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIG. 1, in some embodiments, each frame can include one or more cross members 114 that span between length members 104 for providing rigidity to the frame and for the mounting of solar panels. Any suitable number of cross members can be used in each frame and the cross members can be positioned at any suitable spacing(s) in some embodiments. As shown, in some embodiments, the cross member(s) can be sized in accordance with the height (in the case of frames 151, 152, 154, and 155) or width (in the case of frame 153) of a standard intermodal cargo container. As shown, in some embodiments, each cross member can be elongated and rectangular; however any suitable shape can be used in some embodiments. For example, in some embodiments, the cross member(s) can be triangular, square, round, trapezoidal, hexagonal, and/or any other suitable shape. Each cross member can be constructed from any suitable material having any suitable shape in some embodiments. For example, in some embodiments, each cross member can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

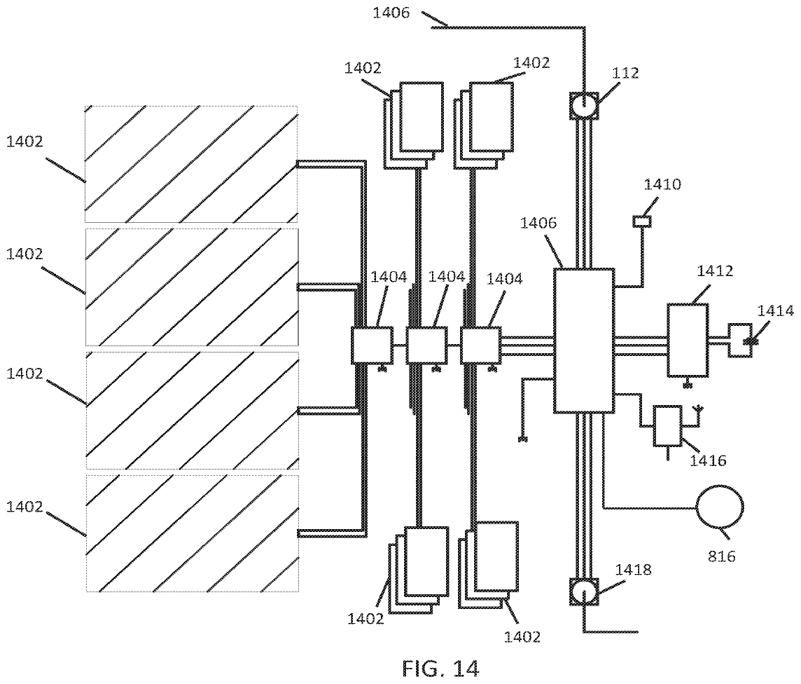

As shown in FIG. 1, in some embodiments, each frame can include one or more electrical boxes 110 to house one or more circuit breakers and/or any other suitable electrical components (e.g., switches, fuses, microinverter 1404 (described below in connection with FIG. 14), circuit breaker 1406 (described below in connection with FIG. 14), meter 1410 (described below in connection with FIG. 14), inverter/charger 1412 (described below in connection with FIG. 14), and power supplies 1416 (described below in connection with FIG. 14)) and one or more of electrical conduits 108, 118, 128, 138, and/or 148 to house wiring. In some embodiments, the electrical box 110 can be any suitable electrical box such as standard electrical box approved for outdoor industrial use. As shown, in some embodiments, the electrical conduits can be sized in accordance with the length of a standard intermodal cargo container and can have a diameter suitable to house the appropriate sized wiring. Any suitable number and configuration of electrical conduit(s) can be used in each frame in accordance with some embodiments. As also shown, in frames 152 and 155, three conduits 108, 118, and 128 run along the length of the frame; however, any suitable number of conduits 108, 118, and 128 can be used. As shown, in frames 151 and 154, conduits 148 can connect an upper receptacle 112 with a lower receptacle 112 on the frame. As shown, in frames 152 and 155, conduits 138 can connect an upper receptacle 112 with a lower receptacle 112 on the frame. As further shown, in some embodiments, each electrical conduit 108, 118, 128, 138, and 148 can be elongated and tubular; however any suitable cross-section shape of the conduit can be used in some embodiments. For example, in some embodiments, the cross section of the electrical conduit 108, 118, 128, 138, and 148 can be triangular, square, round, trapezoidal, hexagonal, and/or any other suitable shape. In some embodiments, the conduit can be formed in any suitable manner. For example, in some embodiments, the conduit can be formed by extrusions, casting, forging, 3d printing, and/or any other suitable manner of forming shaped material. In some embodiments, the conduit can be formed from any suitable substance. For example, in some embodiments, the conduit can be formed from aluminum, iron, stainless, steel, plastic, fiberglass, KEVLAR, carbon fiber, and/or any other suitable substance.

While electrical boxes 110 and conduits 138 and 148 are illustrated at one end of frames 151, 152, 154, and 155, electrical boxes 110 and conduits 138 and 148 can additionally or alternatively be located at the other end of these frames and other frames described herein. Also, it should be understood that electrical boxes as used herein can be any suitable size in some embodiments.

As shown in FIG. 1 in some embodiments, the frame can include electrical receptacles 112 for external wiring connections. In some embodiments, the electrical receptacles 112 can be any suitable standard electrical receptacle approved for outdoor industrial use.

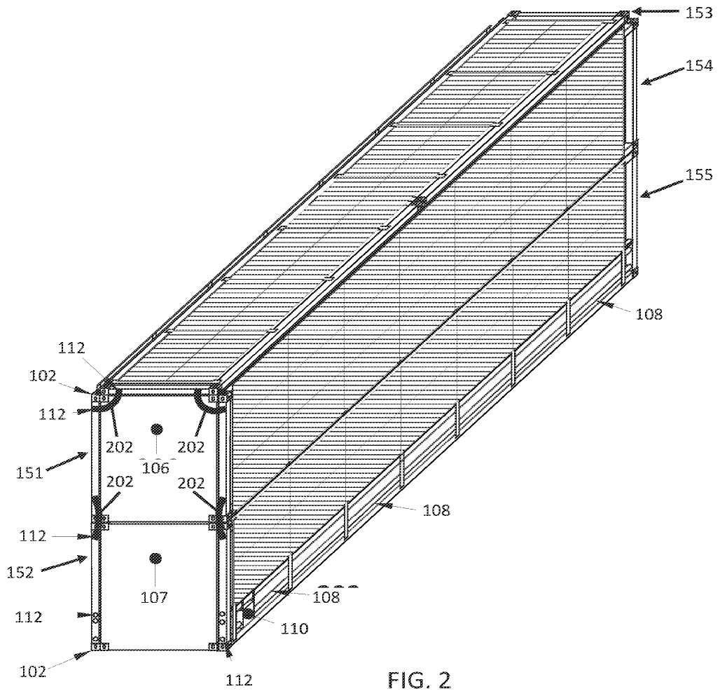

As shown in FIG. 2, in some embodiments, frames 151, 152, 153, 154, and 155 can be attached to the sides and top of double stacked cargo containers 106 and 107. In some embodiments, one can use the frames to affix solar panels to intermodal cargo shipping containers to provide power for any suitable purpose (e.g., to charge batteries, directly power motors, and/or to drive other equipment that uses electricity (e.g., air conditioners, refrigeration, etc.)). In some embodiments, the frames can be attached to the cargo containers 106 and/or 107 when the cargo containers are loaded upon a train car, truck trailer, truck bed, or other vehicle. The frames can be secured to the intermodal cargo containers using cubed corners 102 and any suitable mechanism for securing cubed corners to each other, in some embodiments. Cubed corners 102 also can be used to load/unload of frames 151, 152, 153, 154, and 155 onto/from the intermodal cargo shipping containers without any modification of intermodal system tools and/or grappling equipment, in some embodiments.

In accordance with some embodiments, the process of attaching frames to a pair of cargo containers 106 and 107 as shown in FIG. 2 can begin with the loading of a cargo container 107 onto a vehicle, such as a flatbed rail car, (not shown). Next, one or more base frame(s) 152 and/or 155 can be attached to container 107 in some embodiments. Frames 152 and/or 155 can be secured to container 107 using cubed corners 102 and any suitable mechanism for securing cubed corners to each other, in some embodiments. A second cargo container 106 can then be placed on top of the first cargo container 107 in some embodiments. Next, one or more mezzanine frames 151 and/or 154 can then attached to the side of container 106 and be stacked onto the one or more base frames 152 and/or 155 (if present). Frames 151 and/or 154 can be secured to container 106 and/or frames 152 and/or 155 using cubed corners 102 and any suitable mechanism for securing cubed corners to each other, in some embodiments. In some embodiments, a cap frame 153 can then be attached to the top of cargo container 106. Frame 153 can be secured to container 106 using cubed corners 102 and any suitable mechanism for securing cubed corners to each other, in some embodiments. As will be apparent to one of ordinary skill in the art, this manner of attaching frames to cargo containers is merely for purposes of illustration, and any suitable manner of attaching frames to containers can be used in some embodiments.

In some embodiments, any suitable cables 202 with any suitable connectors can be used to connect receptacles 112 on adjacent ones of frames 151, 152, 153, 154, and 155. Although not shown in FIG. 2, receptacles 112 and any suitable cables with any suitable connectors can be used to connect two or more cargo containers on adjacent train cars, tandem trailers, ship locations, etc.

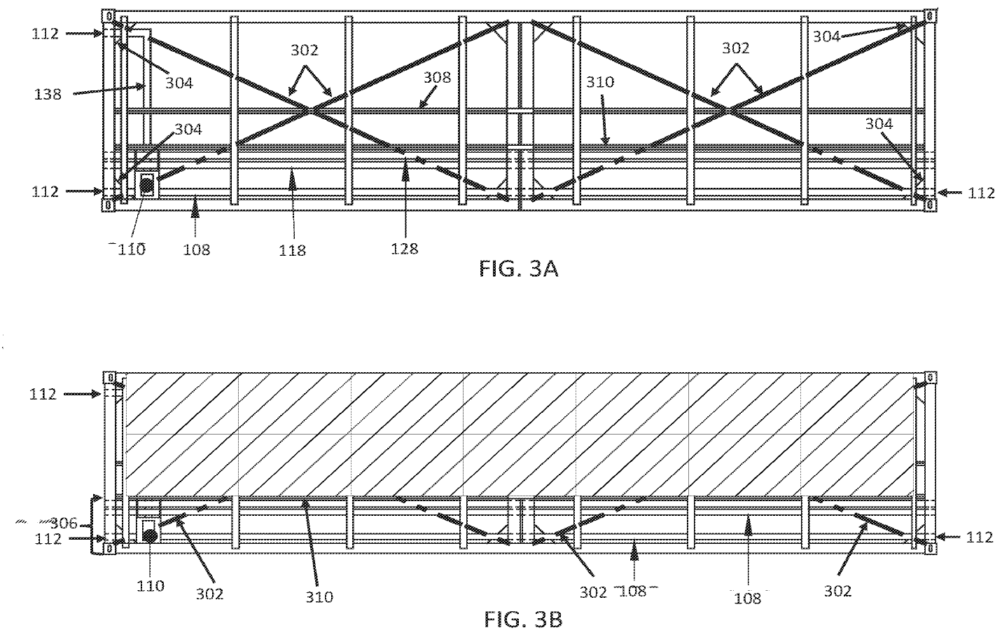

Turning to FIGS. 3A and 3B, further details of an example of base frames 152 and/or 155 in accordance with some embodiments are shown. As described in connection with FIG. 1 above, frames 152 and/or 155 can be sized in accordance with the sizes of the sides of a standard intermodal cargo container. As shown, the base frame can be rectangular; however any suitable shape can be used in some embodiments. For example, in some embodiments, the base frame can be triangular, square, round, trapezoidal, hexagonal, and/or any other suitable shape. Each base frame can be constructed from any suitable material having any suitable shape in some embodiments. For example, in some embodiments, each base frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIGS. 3A and 3B, in some embodiments, the base frame can include electrical receptacles 112 which can be coupled to any suitable wires in electrical box 110 and/or electrical conduits 108, 118, 128, and/or 138. During operation, in some embodiments, the base frame wiring can be coupled to the receptacles 112 to permit cables 202 that couple the wiring to other solar panel frames, rail cars, a locomotive, truck, electric vehicles, utility grid connection, battery charge stations, and/or any other suitable equipment and/or devices. In some embodiments, the receptacles 112 can be any suitable standard receptacles 112 approved for outdoor industrial use.

As also shown in FIGS. 3A and 3B, in some embodiments, the base frame can include cross bracing 302 to help keep the frame corners at ˜90 degrees (i.e., “square”). Any suitable form of cross bracing can be used in some embodiments. In some embodiments, a reinforcing member 308 can run the length of the frame and can be used to support the cross bracing. For example, the cross bracing can include cables, cable ends, turnbuckles, rods, angle material, box material, round material, tubular material, plate material, and/or any other suitable type of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As further shown in FIGS. 3A and 3B, in some embodiments, the base frame can contain corner bracing 304, such as rectangular steel; however any suitable corner bracing can be used in some embodiments. For example, in some embodiments, the corner bracing can be triangular, square, round, trapezoidal, hexagonal, and/or any other suitable shape. Each corner bracing can be constructed from any suitable material having any suitable shape in some embodiments. For example, in some embodiments, each corner bracing can be formed from angle material, box material, round material, tubular material, plate material and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIG. 3B, in some embodiments, the base frame excludes solar panels in a base region 306 of the frame in some embodiments. For example, in some embodiments, solar panels are not located at the base of the frame as they may be covered by sides of the well in an intermodal cargo container well rail car. In some embodiments, a support member 310 can be provided to support the bottom sides of the solar panels at the top of region 306 as shown in FIGS. 3A and 3B.

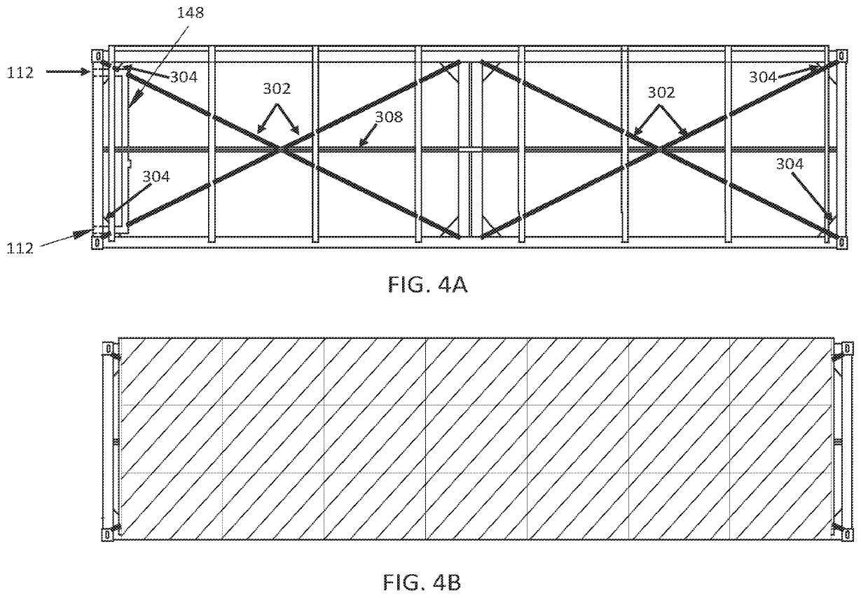

Turning to FIGS. 4A and 4B, further details of an example of mezzanine frames 151 and/or 154 in accordance with some embodiments are shown. As described in connection with FIG. 1 above, frames 151 and/or 154 can be sized in accordance with the sizes of the sides of a standard intermodal cargo container. As shown, in some embodiments, the mezzanine frame contains solar panels across the height of the frame (including near its base). As shown, the mezzanine frame can be rectangular in some embodiments; however any suitable shape can be used in some embodiments. For example, in some embodiments, the mezzanine frame can be triangular, square, round, trapezoidal, hexagonal, and/or any other suitable shape. Each mezzanine frame can be constructed from any suitable material having any suitable shape in some embodiments. For example, in some embodiments, each mezzanine frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIGS. 4A and 4B, in some embodiments, the mezzanine frame can include electrical receptacles 112 coupled to one of more electrical conduits 148. During operation, in some embodiments, the mezzanine frame wiring can be coupled to the receptacles to permit jumpers that couple the wiring to other solar panel frames, rail cars, a locomotive, truck, electric vehicles, utility grid connection, battery charge stations, and/or any other suitable equipment and/or devices. In some embodiments, the receptacles 112 can be any suitable standard receptacles approved for outdoor industrial use.

As also shown in FIGS. 4A and 4B, in some embodiments, the mezzanine frame can include cross bracing 302 to help keep the frame corners at ˜90 degrees (i.e., “square”). Any suitable form of cross bracing can be used in some embodiments. In some embodiments, a reinforcing member 308 can run the length of the frame and can be used to support the cross bracing. For example, the cross bracing can include cables, cable ends, turnbuckles, rods, angle material, box material, round material, tubular material, plate material, and/or any other suitable type of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As further shown in FIGS. 4A and 4B, in some embodiments, the mezzanine frame can contain corner bracing 304, such as rectangular steel; however any suitable corner bracing can be used in some embodiments. For example, in some embodiments, the corner bracing can be triangular, square, round, trapezoidal, hexagonal, and/or any other suitable shape. Each corner bracing can be constructed from any suitable material having any suitable shape in some embodiments. For example, in some embodiments, each corner bracing can be formed from angle material, box material, round material, tubular material, plate material and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

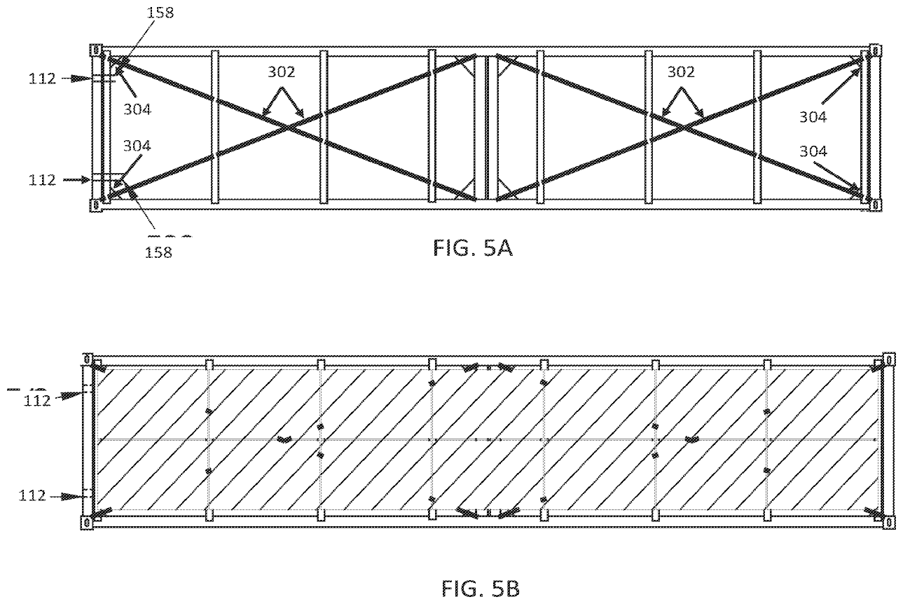

Turning to FIGS. 5A and 5B, further details of an example of a cap frame 153 in accordance with some embodiments are shown. As described in connection with FIG. 1 above, frame 153 can be sized in accordance with the sizes of the sides of a standard intermodal cargo container. As shown, in some embodiments, the cap frame can be rectangular; however any suitable shape can be used in some embodiments. For example, in some embodiments, the cap frame can be triangular, square, round, trapezoidal, hexagonal, and/or any other suitable shape. Each cap frame can be constructed from any suitable material having any suitable shape in some embodiments. For example, in some embodiments, each cap frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIGS. 5A and 5B, in some embodiments, the cap frame can include receptacles 112 coupled to one or more electrical conduits 158. During operation, in some embodiments, the cap frame wiring couples to the receptacles to permit jumpers to couple the wiring to other solar panel frames, rail cars, a locomotive, truck, electric vehicles, utility grid connection, battery charge stations, and/or any other suitable equipment and/or devices. In some embodiments, the receptacles 112 can be any suitable standard receptacles approved for outdoor industrial use.

As also shown in FIGS. 5A and 5B, in some embodiments, the cap frame can include cross bracing 302 to help keep the frame corners at ˜90 degrees (i.e., “square”). Any suitable form of cross bracing can be used in some embodiments. For example, the cross bracing can include cables, cable ends, turnbuckles, rods, angle material, box material, round material, tubular material, plate material, and/or any other suitable type of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As further shown in FIGS. 5A and 5B, in some embodiments, the cap frame can contain corner bracing 304, such as rectangular steel; however any suitable corner bracing can be used in some embodiments. For example, in some embodiments, the corner bracing can be triangular, square, round, trapezoidal, hexagonal, and/or any other suitable shape. Each corner bracing can be constructed from any suitable material having any suitable shape in some embodiments. For example, in some embodiments, each corner bracing can be formed from angle material, box material, round material, tubular material, plate material and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

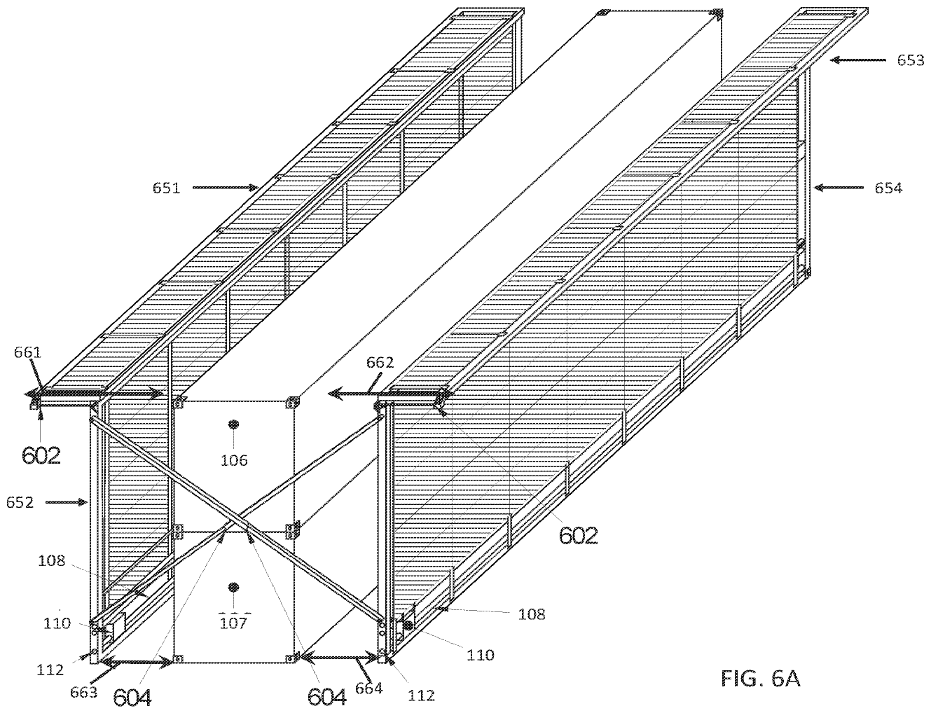

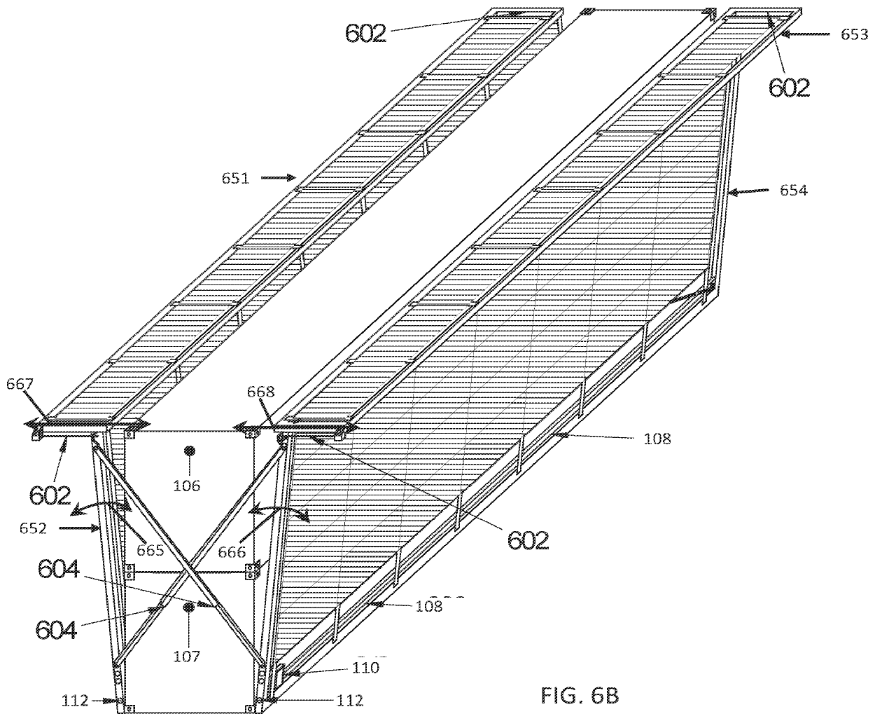

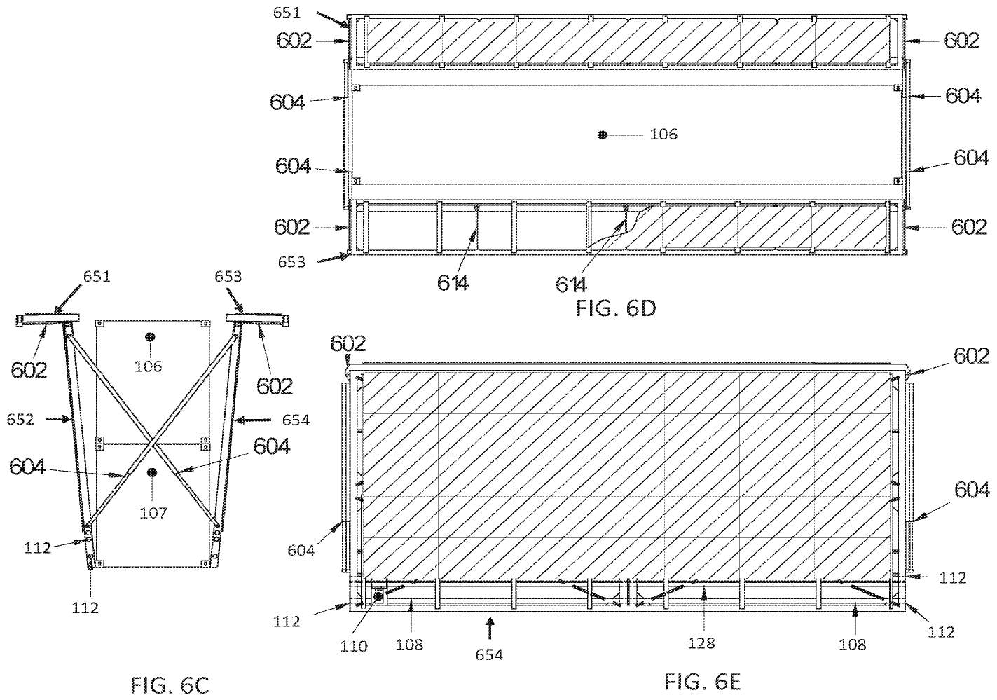

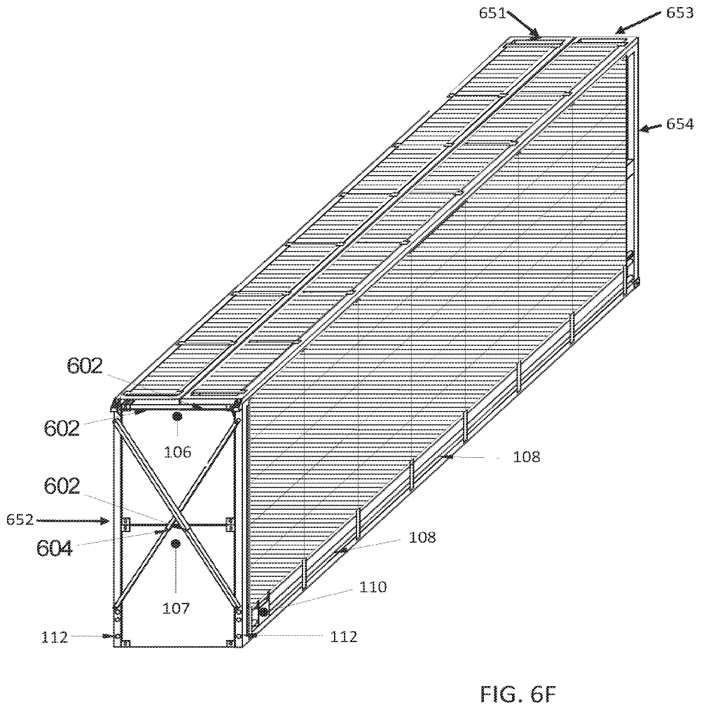

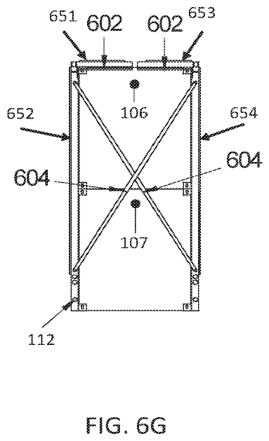

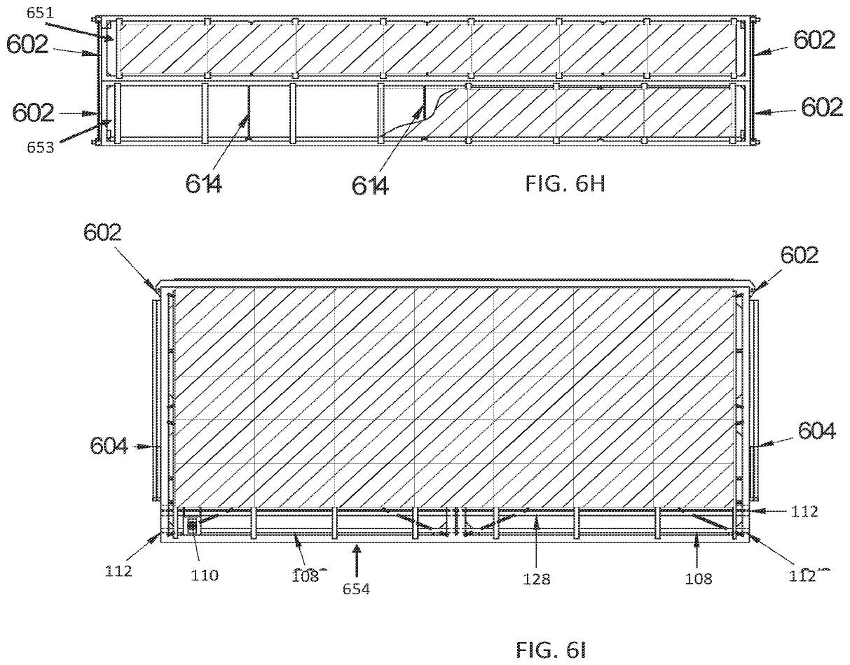

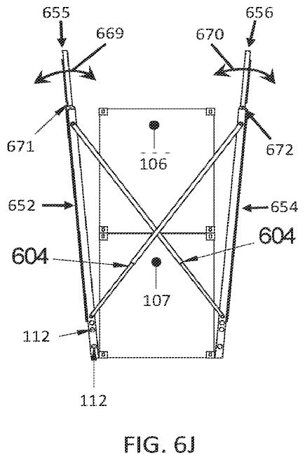

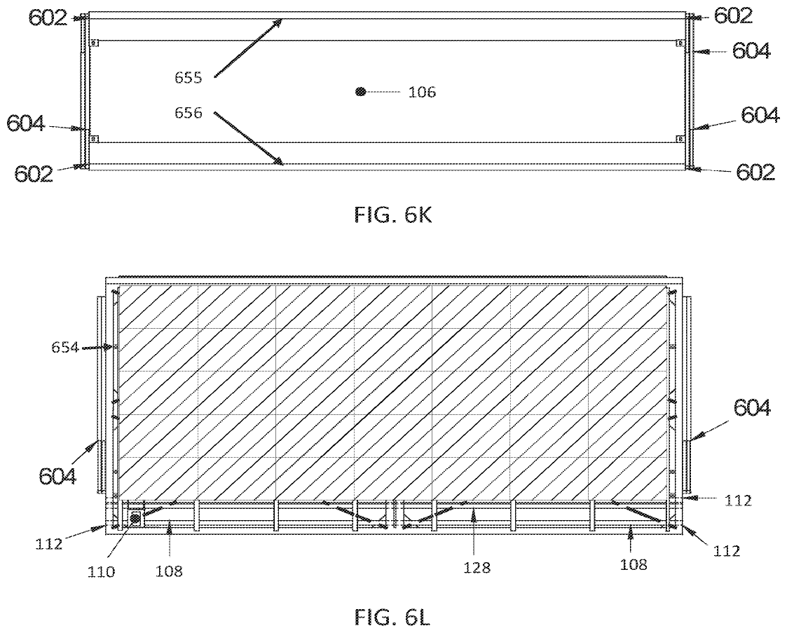

Turning to FIGS. 6A-6L, other embodiments of frames for attaching solar panels to cargo containers are shown, in some embodiments. As can be seen from FIGS. 6A, 6B, and 6F, the frames can go from a maximum open position in FIG. 6A, to a normal open position in FIG. 6B, to a closed position in FIG. 6F in accordance with some embodiments.

In accordance with some embodiments, the frames shown in FIGS. 6A-6L can be sized in accordance with the sizes of the sides and top of a standard intermodal cargo container. As shown, in some embodiments, the frames are rectangular; however any suitable shape can be used in some embodiments. For example, in some embodiments, the frames can be triangular, square, round, trapezoidal, hexagonal, and/or any other suitable shape. Each frame can be constructed from any suitable material having any suitable shape in some embodiments. For example, in some embodiments, each frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIGS. 6A-6I, four frames 651, 652, 653, and 654 can be used to secure a set of solar panels around a pair of cargo containers. Frames 651 and 653 can remain essentially in a horizontal plane, while frames 652 and 654 can remain essentially in a vertical plane. To allow movement between the maximum open position shown in FIG. 6A to the closed position shown in FIG. 6F, the bottoms of frames 652 and 654 can each be mounted in tracks (or other similar mechanism) of a vehicle (e.g., train car, truck bed, ship) that allow the bottoms of these frames to move away from container 107 while being secured to the vehicle as shown by arrows 663 and 664. In some embodiments, the maximum open position of the frames can be illustrated by FIG. 6B. In such embodiments, the bottoms of frames 652 and 654 can each be secured to a vehicle (e.g., train car, truck bed, ship) by one or more hinges close to the bottom of container 107 such that container 107 can still be lowered between the frames and raise up from between the frames during a loading and unloaded procedure. These hinges can allow the frames to pivot away from containers 106 and 107 to allow space for loading and unloading the containers as shown by arrows 665 and 666 of FIG. 6B in some embodiments.

During operation, the frame can be configured to move along the above-described tracks or pivot about the above-described hinges in some embodiments under any suitable force in some embodiments. For example, in some embodiments, the frame can move or pivot under the force of a hydraulic, electrical, mechanical, or pneumatic actuator not shown.

As shown in FIGS. 6A and 6B, frames 652 and 654 can be connected by diagonal expandable support bracing 604 at the ends of the frames, in some embodiments. During operation, the frame can be configured to move outward through expansion or contraction of support bracing 604, and slide on the above-described tracks or pivot about the above-described hinges, in some embodiments. The support bracing can expand or contract under any suitable force in some embodiments. For example, in some embodiments, the frame can expand or contract under the force of a hydraulic, electrical, mechanical, or pneumatic actuator. One or more such actuators can be integral to support bracing 604 in some embodiments.

As also shown in FIGS. 6A and 6B, frames 651 and 653 can extend outward along paths shown by arrows 661 and 662 in FIG. 6A and shown by arrows 667 and 668 in FIG. 6B, in some embodiments. This open position can permit gantry loading of cargo containers in some embodiments. Frames 651 and 652 can extend and contract under any suitable force in some embodiments. For example, in some embodiments, the frames can extend and contract under the force of a hydraulic, electrical, mechanical, or pneumatic actuator 602.

As shown, frames 652 and 654 can include receptacles 112, electrical boxes 110, and conduits 108 and 128 as described above in connection with FIGS. 1-5 in some embodiments.

In some embodiments, the frames can include cross bracing in a similar manner to that described above in connection with FIGS. 1-5 in some embodiments.

In some embodiments, the frame can include corner bracing in a similar manner to that described above in connection with FIGS. 1-5 in some embodiments.

In some embodiments, rather than using top frames 651 and 653 which move as shown by arrows 661, 662, 667, and 668, top frames 655 and 656 can be used which move as shown by arrows 669 and 670 about pivot points 671 and 672. Top frames 655 and 656 can open and close under any suitable force in some embodiments. For example, in some embodiments, the frame can open and closet under the force of a hydraulic, electrical, mechanical, or pneumatic actuator not shown.

As shown in FIGS. 6F, 6G, and 6H, the top frames (whether 651 and 653 or 655 and 656) can close inward to a closed position once gantry loading of cargo containers is complete in some embodiments.

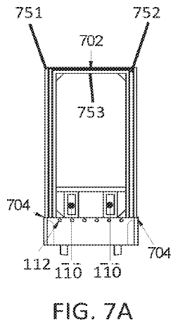

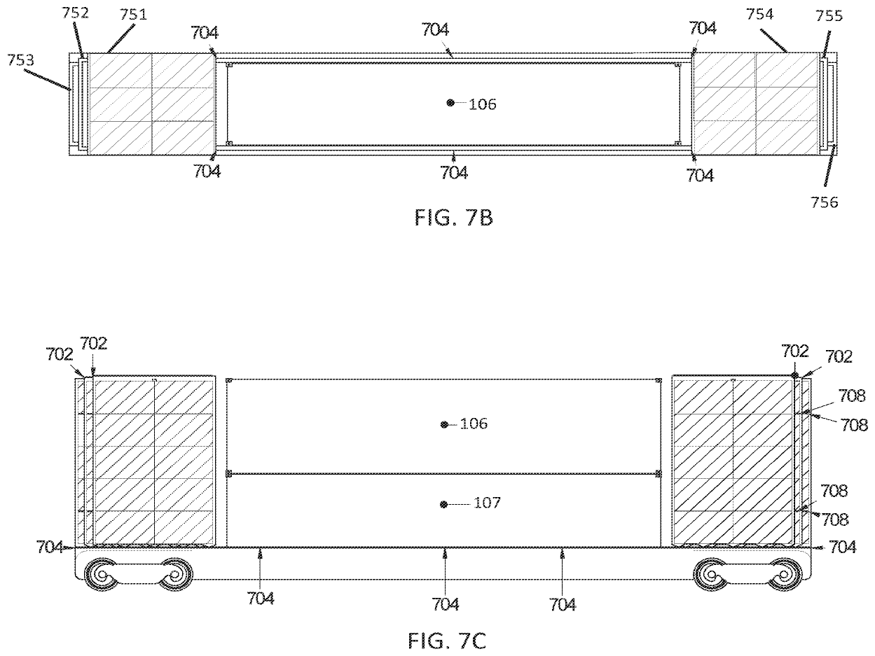

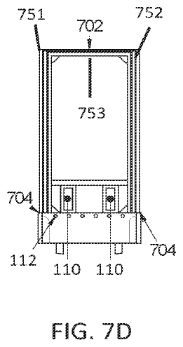

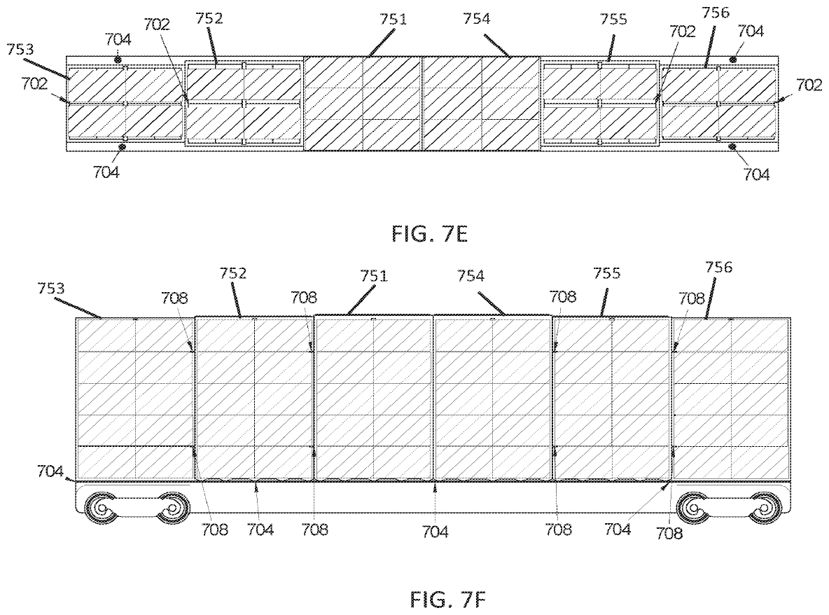

Turning to FIGS. 7A-7F, telescoping frames 751-756 for solar panels that enclose one or more cargo containers when closed are illustrated in accordance with some embodiments. As shown in these figures, when the frames are in the open position (e.g., as shown in FIGS. 7B and 7C), the cargo containers can be accessed, loaded, and/or unloaded from above or their sides. When the frames are in their closed position (e.g., as shown in FIGS. 7E and 7F), the cargo containers are enclosed by frames 751-756.

As shown in FIGS. 7A-7F, in some embodiments, the frames can be sized in accordance with the dimensions of a standard rail car that hauls cargo containers. As shown, the frames can be square or rectangular; however any suitable shape can be used in some embodiments. For example, in some embodiments, the frames can be triangular, round, trapezoidal, hexagonal, and/or any other suitable shape. Each frame can be constructed from any suitable material having any suitable shape in some embodiments. For example, in some embodiments, each frame can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

As shown in FIGS. 7A and 7D, frames 753 and 756 include electrical receptacles 112 in some embodiments. During operation, in some embodiments, frame wiring couples to receptacles 112 to permit jumpers to couple the wiring to other solar panel frames, rail cars, a locomotive, truck, electric vehicles, utility grid connection, battery charge stations, and/or any other suitable equipment and/or devices. In some embodiments, receptacles 112 can be any suitable standard receptacles approved for outdoor industrial use.

In some embodiments, the frames can include cross bracing in a similar manner to that described above in connection with FIGS. 1-5 in some embodiments.

In some embodiments, the frame can include corner bracing in a similar manner to that described above in connection with FIGS. 1-5 in some embodiments.

As shown in FIGS. 7A-7F, frames 751, 752, 754, and 755 can include wheels affixed to the base of the frames that ride in channels 704 of a vehicle (e.g., a rail car, a truck bed, a ship) in some embodiments. During operation, the wheels can ride in channels 704 of the vehicle so that the frames roll along the base to open and close in a telescopic manner to permit gantry and side loading of cargo containers in some embodiments. The frames can move horizontally under any suitable force, which can be applied along lines 708 in some embodiments. For example, in some embodiments, the frame can move horizontally under the force of one or more hydraulic, electrical, mechanical, or pneumatic actuators applied alone lines 708.

As shown in FIGS. 7A-7F the frame can include electrical boxes 110 (as described above) and electrical channels 702 to house wiring in some embodiments. As shown, in some embodiments, electrical channels 702 can be sized in accordance with the length of a standard intermodal cargo container and have a width suitable to house the appropriate sized wiring. As shown, in some embodiments, each electrical channel 702 can be elongated and rectangular; however any suitable shape can be used in some embodiments. For example, in some embodiments, each electrical channel 702 can have a cross-section that is triangular, square, round, trapezoidal, hexagonal, and/or any other suitable shape. Each electrical channel 702 can be constructed from any suitable material having any suitable shape in some embodiments. For example, in some embodiments, each electrical channel 702 can be formed from angle material, box material, round material, tubular material, plate material, and/or any other suitable shape of material. In some embodiments, the material can be formed in any suitable manner. For example, in some embodiments, the material can be formed by extrusions, casting, forging, 3d printing, and/or any other suitable manner of forming shaped material. In some embodiments, the material can be formed from any suitable substance. For example, in some embodiments, the material can be formed from aluminum, iron, stainless, steel, plastic, fiberglass, KEVLAR, carbon fiber, and/or any other suitable substance.

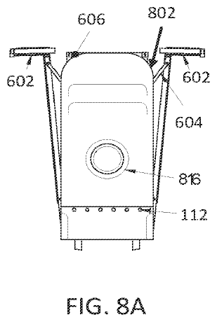

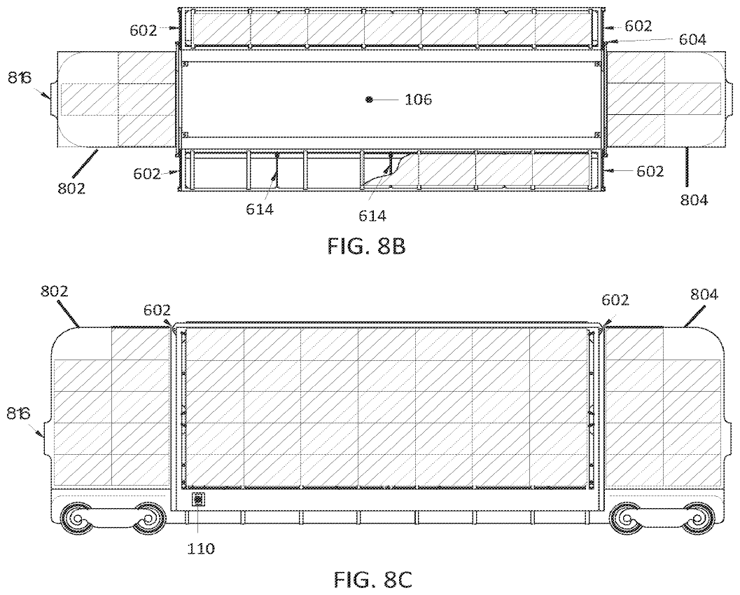

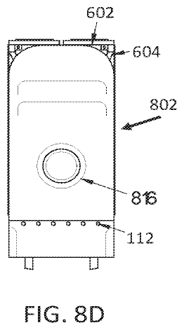

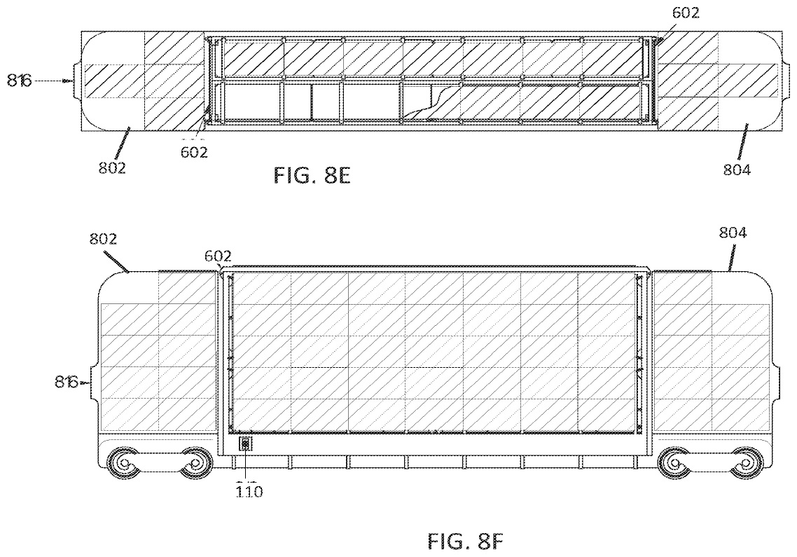

Turning to FIGS. 8A-8F, a train car with an inductive coupling at each end of the car is shown in accordance with some embodiments. As shown in these figures, a coil 816 can be provided for inductive power transfer. During operation, in some embodiments, the rail car can transfer energy in a contactless manner to and/or from an adjacent coil on another rail car, a charging station, and/or a utility grid connection by alignment of the adjacent coil with coil 816. As shown, the coil can be circular; however any suitable shape can be used in some embodiments. For example, in some embodiments, the coil can be triangular, square, round, trapezoidal, hexagonal, and/or any other suitable shape.

As shown in FIGS. 8A-8F, body sections 802 and 804 can be provided in some embodiments. These body sections can have any suitable shape and be formed from any suitable material in any suitable manner. As also shown, solar panels can be mounted on the body sections in some embodiments.

As shown in FIGS. 8A-8F, the body sections can include electrical receptacles 112 in some embodiments. During operation, in some embodiments, the frame wiring couples to the receptacles 112 to permit jumpers to couple the wiring to other solar panel frames, rail cars, a locomotive, truck, electric vehicles, utility grid connection, battery charge stations, and/or any other suitable equipment and/or devices. In some embodiments, the receptacles 112 can be any suitable standard receptacles approved for outdoor industrial use.

In some embodiments, the frames adjacent to cargo container can be implemented and operated as described above for the frames shown in FIGS. 6A-6L.

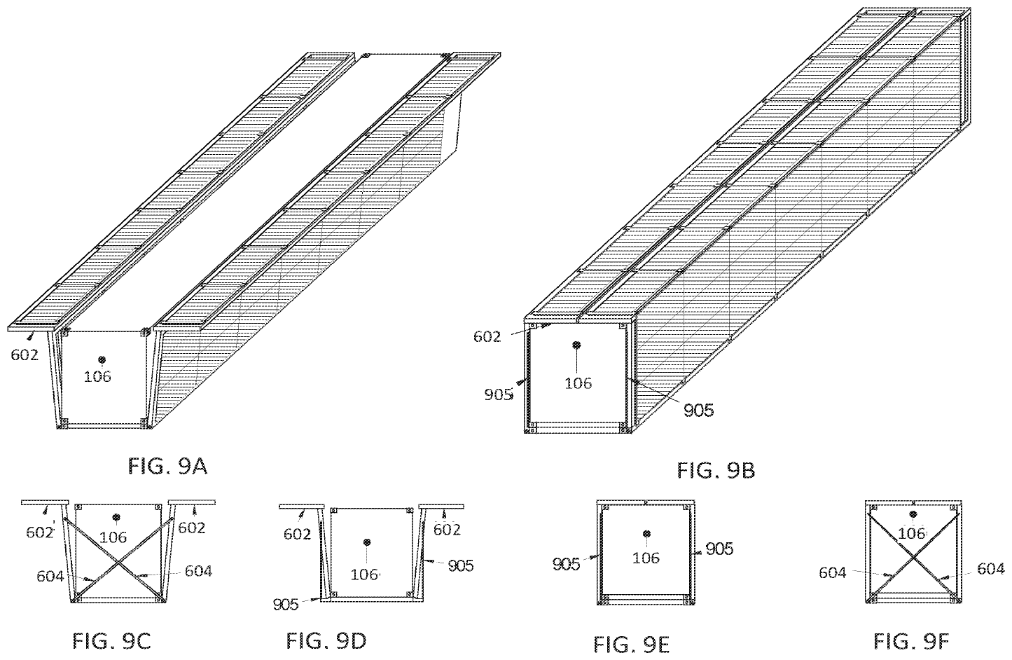

Turning to FIGS. 9A-9F, examples of frames as described above in connection with FIGS. 6A-6L but for as single cargo container are illustrated in accordance with some embodiments. Additionally or alternatively to what is described in connection with FIGS. 6A-6L for moving the frames described therein, in some embodiments the frames of FIGS. 9A-9F can move under force of a hydraulic, electrical, mechanical, or pneumatic actuator 905.

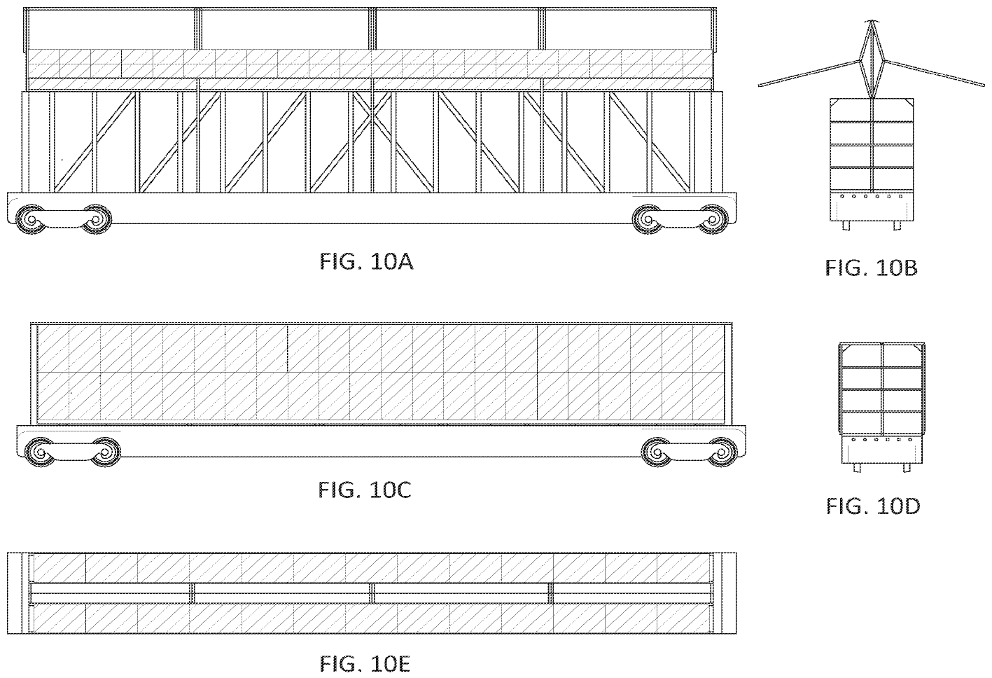

Turning to FIGS. 10A-10E, illustrations of an example of frames for center-beam railcar in accordance with some embodiments are shown. As illustrated in FIGS. 10A and 10B, the frames are in an open position to allow the center-beam railcar to be loaded and unloaded. As also shown in FIG. 10B, the frames can attach to the top of the center-beam of the rail car and pivot upward to open and downward to close in some embodiments. FIGS. 10C-10E show the frames in a closed position in accordance with some embodiments.

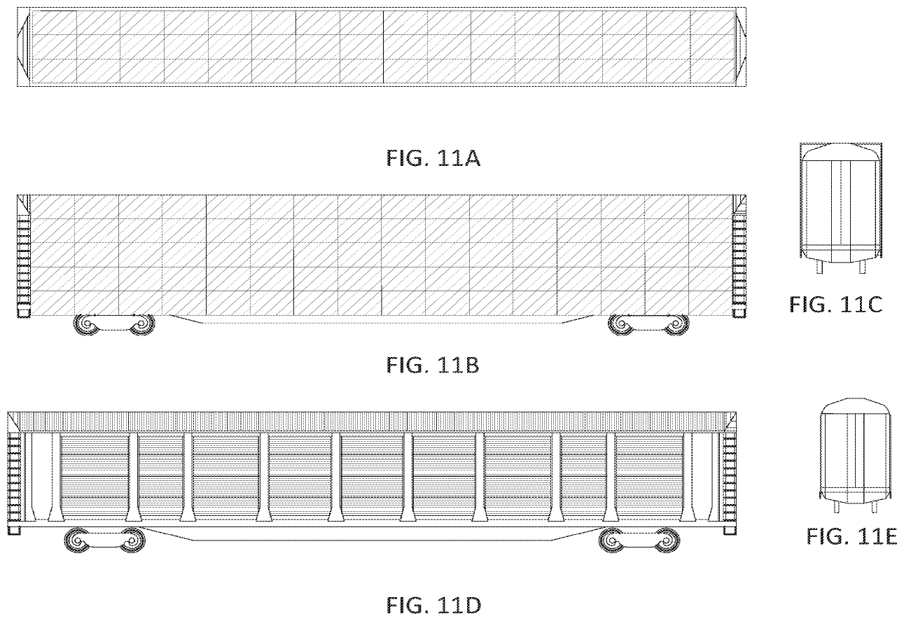

Turning to FIGS. 11A-11C, illustrations of solar panels mounted on an automobile carrier railcar in accordance with some embodiments are shown. In some embodiments, in an implementation as shown in FIGS. 11A-11C, the solar panels do not move with respect to the railcar. FIGS. 11D and 11E show the same railcar but without the solar panels.

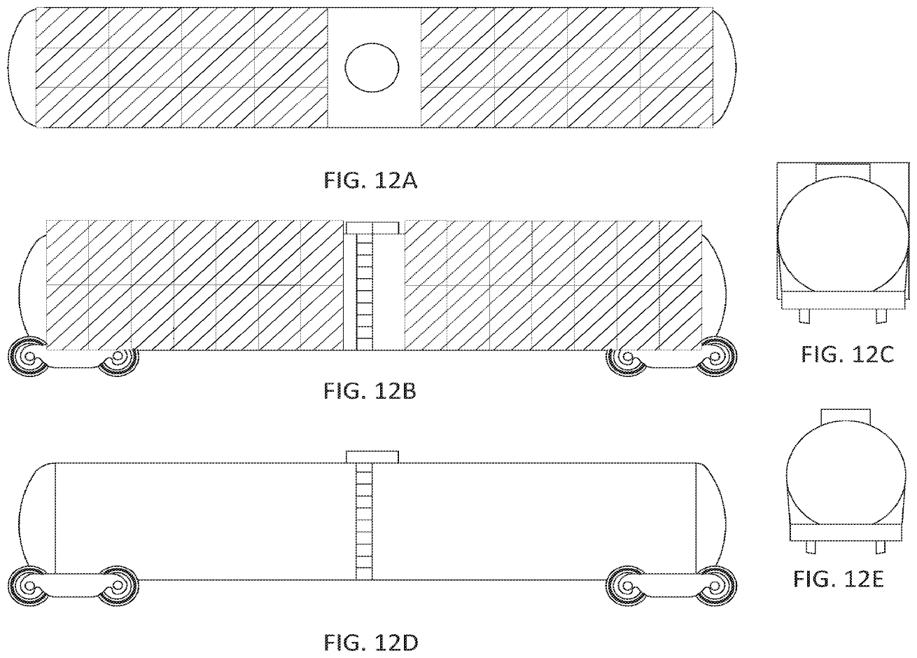

Turning to FIGS. 12A-12C, illustrations of solar panels mounted on a tanker railcar in accordance with some embodiments are shown. In some embodiments, in an implementation as shown in FIGS. 12A-12C, the solar panels do not move with respect to the railcar. FIGS. 12D and 12E show the same railcar but without the solar panels.

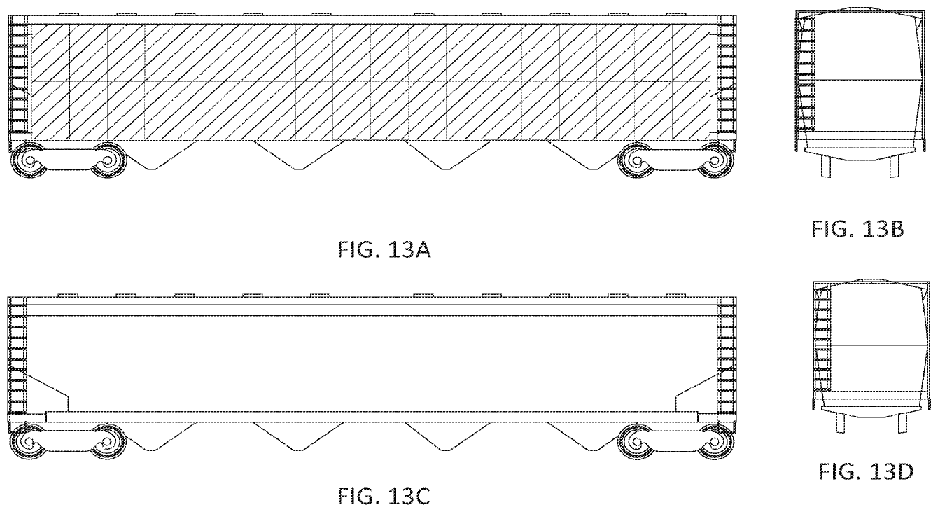

Turning to FIGS. 13A-13B, illustrations of solar panels mounted on a hopper railcar in accordance with some embodiments are shown. In some embodiments, in an implementation as shown in FIGS. 13A-13B, the solar panels do not move with respect to the railcar. FIGS. 13C and 13D show the same railcar but without the solar panels.

Turning to FIG. 14, a schematic of circuitry 1400 that can be connected to solar panels as described herein in accordance with some embodiments is illustrated. As shown, solar panel arrays 1402 can be connected to microinverters 1404.

Any suitable solar panels can be used solar panel arrays 1402 in some embodiments. For example, in some embodiments, solar panel arrays 1402 can be implemented using model CS3k-310 available from CANADIAN SOLAR of Guelph, Ontario, Canada. Each solar panel array 1402 can be implemented using any suitable number (including one) of solar panels, and the solar panels can be connected in any suitable manner (e.g., in series, in parallel, using a combination of serial and parallel connections).

Any suitable microinverters 1404 can be used in some embodiments. For example, in some embodiments, microinverters 1404 can be implemented using model APsystems YC1000-3-480 from Altenergy Power System Inc. of Seattle, Washington. Any suitable number of microinverters 1404 can be used, each microinverter can be connected to any suitable number (including one) of solar panels, and the outputs of any suitable number of microinverters can be combined, in some embodiments.

The outputs of microinverters 1404 can be connected to any suitable circuit breakers 1406 in some embodiments.

The circuit breakers 106 can be connected to receptacles 112, which can be connected by a cable 1408 to another vehicle.

A meter 1410 can also be installed to monitor the voltage, current, and/or power produced by circuitry 1400. Any suitable meter can be used in some embodiments.

An inverter/charger 1412 can be connected to the circuit breakers and also to a battery bank 1414 in some embodiments. When the solar panels are producing energy, inverter/charger 1412 can be used to charge battery bank 1414 in some embodiments. When the solar panels are not producing energy, inverter/charger 1412 can produce AC (e.g., 3 phase, 480 VAC) from the charge stored in battery bank 1414 in some embodiments.

Any suitable one or more power supplies 1416 can also be connected to circuit breakers 1406 in some embodiments. These power supplies can be used to provide power to any suitable device(s), such as a computer, a WiFi routers, an Internet of Things (IoT) device, an artificial intelligence module, an actuator controller, etc.

Any suitable one or more outlets 1418 can also be connected to circuit breakers 1406 in some embodiments.

In some embodiments, inductive coupling 816 can be coupled to circuit breakers 1406.

In some embodiments, any suitable one or more of microinverter 1404, circuit breaker 1406, meter 1410, inverter/charger 1412, and power supplies 1416 can be mounted in electrical box 110 described further above.

In some embodiments, a railcar as described above (e.g., the railcar shown in FIGS. 8A-8F) can be driven by motors in or coupled to the wheels shown, and the motors can be powered by battery bank 1414 (if DC motors) or inverter/charger 1412 (if AC motors). Any suitable controller can control the motors under the control of any suitable computer in some embodiments. In some embodiments, this computer can receive input from any suitable sensors, such as cameras, accelerometers, global positioning system devices, temperature sensors, microphones, contact sensors, proximity sensors, magnetic sensors, etc. The computer can use any suitable technology to control the operation and location of the railcar.

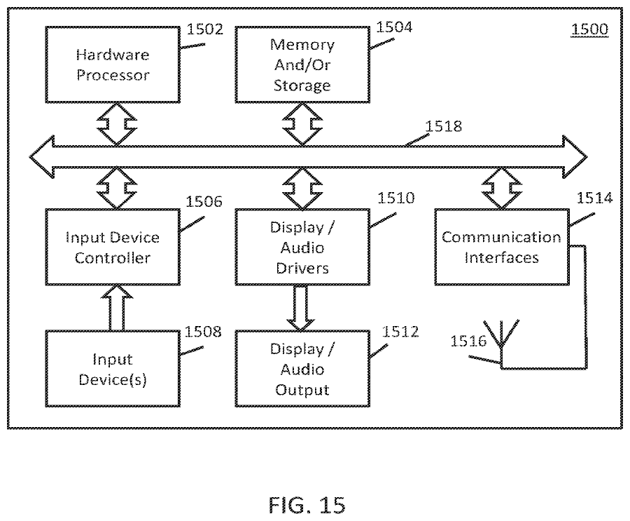

The computer can be implemented using any suitable general-purpose computer or special-purpose computer in some embodiments. Any such general-purpose computer or special-purpose computer can include any suitable hardware. For example, as illustrated in example hardware 1500 of FIG. 15, such hardware can include hardware processor 1502, memory and/or storage 1504, an input device controller 1506, an input device 1508, display/audio drivers 1510, display and audio output circuitry 1512, communication interface(s) 1514, an antenna 1516, and a bus 1518.

Hardware processor 1502 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 1504 can be any suitable memory and/or storage for storing programs, data, and/or any other suitable information in some embodiments. For example, memory and/or storage 1504 can include random access memory, read-only memory, flash memory, hard disk storage, optical media, and/or any other suitable memory.

Input device controller 1506 can be any suitable circuitry for controlling and receiving input from input device(s) 1508 in some embodiments. For example, input device controller 1506 can be circuitry for receiving input from an input device 1508, such as a touch screen, from one or more buttons, from a voice recognition circuit, from a microphone, from a camera, from an optical sensor, from an accelerometer, from a temperature sensor, from a near field sensor, and/or any other type of input device.

Display/audio drivers 1510 can be any suitable circuitry for controlling and driving output to one or more display/audio output circuitries 1512 in some embodiments. For example, display/audio drivers 1510 can be circuitry for driving one or more display/audio output circuitries 1512, such as an LCD display, a speaker, an LED, or any other type of output device.

Communication interface(s) 1514 can be any suitable circuitry for interfacing with one or more communication networks. For example, interface(s) 1514 can include network interface card circuitry, wireless communication circuitry, and/or any other suitable type of communication network circuitry.

Antenna 1516 can be any suitable one or more antennas for wirelessly communicating with a communication network in some embodiments. In some embodiments, antenna 1516 can be omitted when not needed.

Bus 1518 can be any suitable mechanism for communicating between two or more components 1502, 1504, 1506, 1510, and 1514 in some embodiments.

Any other suitable components can additionally or alternatively be included in hardware 1500 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Below are example embodiments:
1. An article comprising
   a. a means to attach a mounting bracket frame to intermodal cargo containers.
2. A mounting bracket frame, comprising
   a. a means to attach said mounting bracket frame to intermodal cargo containers of any size, and
   b. a means to mount power generating devices to said mounting bracket frame.
3. A power generation system for transit systems comprising
   a. a means for attaching said power generation devices to said transit system, utilizing standard intermodal loading equipment, and
   b. an array of said power generating devices, mounted to the top or side of intermodal cargo containers.
4. A mounting bracket frame system comprising:
   a. affixed power generation devices mounted in close proximity to the surface of intermodal cargo containers, and
   b. said power generation devices provide power generation while cargo containers are in motion.
5. An article of a mounting bracket frame, comprising:
   a. cubed shaped corners with holes on the outer sides for grappling access by intermodal cargo container equipment,
   b. tubing, connected to said cubed shaped corners,
   c. cross framing to square up said mounting bracket frame,
   d. diagonal plates mounted to the inside corners of said mounting bracket frame, and
   e. vertical or horizontal plates running the height or width of said mounting bracket frame, and bolted on power generation devices to said vertical or horizontal plates,
      wherein, (a) a user of the said mounting bracket frames may utilize standard intermodal grappling equipment to attach said mounting bracket frames with affixed said power generation devices, to standard intermodal cargo shipping containers on a variety of transit systems, such as railroads, trucks or containerships, (b) the user may connect said power generation devices to the transit system motive power storage system, or batteries to be electrically charged, and (c) provide ancillary clean renewable energy to the overall transit system hauling said mounting bracket frames with said power generation devices affixed.
6. A device for attaching solar panels to a cargo container comprising:
   a frame having:
      a plurality of cubed corners configured to mechanically connect to cubed corners on the cargo container;
      a plurality of frame members coupled to the cubed corners; and
      at least one plate coupled to the plurality of frame members on which at least one solar panel can be mounted.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A railcar comprising:
a bed; and
at least one frame containing at least one solar panel that is moveably attached to the bed such that, in an opened position, cargo can be loaded onto the bed, and such that, in a closed position, the at least one frame at least partially covers the cargo.

2. The railcar of claim 1, wherein a first frame of the at least one frame has a first top portion that is parallel to the bed and two first side portions that are on opposite long sides of the bed, that are parallel to each other, and that support the first top portion.

3. The railcar of claim 2, wherein a second frame of the at least one frame has a second top portion that is parallel to the bed and two second side portions that are on opposite long sides of the bed, that are parallel to each other, and that support the second top portion.

4. The railcar of claim 3, wherein a third frame of the at least one frame has a third top portion that is parallel to the bed and two third side portions that are on opposite long sides of the bed, that are parallel to each other, and that support the third top portion, wherein, when in the opened position, the third top portion is at least partially above the first top portion.

5. The railcar of claim 4, wherein a fourth frame of the at least one frame has a fourth top portion that is parallel to the bed and two fourth side portions that are on opposite long sides of the bed, that are parallel to each other, and that support the fourth top portion, wherein, when in the opened position, the fourth top portion is at least partially above the second top portion.

6. The railcar of claim 1, wherein the at least one frame has wheels on which the at least one frame rides in a channel formed in the bed.

7. The railcar of claim 1, wherein the at least one frame is attached to the bed by a hinge that allows the frame to pivot outward from the center of the bed from the closed to the opened position.

8. The railcar of claim 7, wherein the at least on frame includes a top portion that covers the cargo when in the closed position and that is configured to slide parallel to a top surface of the bed.

9. The railcar of claim 7, wherein the at least on frame includes a top portion that covers the cargo when in the closed position and that is configured to rotate about an axis parallel to a long side of the bed.

10. The railcar of claim 1, further comprising an actuator that causes the at least one frame to move.

11. The railcar of claim 1, wherein the cargo is a cargo container.

12. The railcar of claim 1, wherein the cargo is two stacked cargo containers.

13. The railcar of claim 1, further comprising an inductive coupling for transferring power from the railcar.

14. The railcar of claim 1, where the railcar is a center-beam railcar.
